(19) United States
(12) Patent Application Publication
(10) Pub. No.: US 2014/0083700 A1
(43) Pub. Date: Mar. 27, 2014

(54) Compositions and Methods for Plug Cementing

(71) Applicant: SCHLUMBERGER TECHNOLOGY CORPORATION, Sugar Land, TX (US)

(72) Inventors: Alhad Phatak, Stafford, TX (US); Carlos Abad, Aberdeen (GB)

(73) Assignee: Schlumberger Technology Corporation, Sugar Land, TX (US)

(21) Appl. No.: 13/627,921

(22) Filed: Sep. 26, 2012

(51) Int. Cl. E21B 33/13; C09K 8/44

(52) U.S. Cl. 166/293; 507/224

(57) ABSTRACT

Compositions comprise water, an acrylate monomer or a methacrylate monomer or a combination thereof, a free-radical polymerization initiator and a water-soluble bromide salt. Such compositions have utility in the context of remedial cementing, plug cementing in particular. The compositions may be pumped into a subterranean well, where they polymerize and form a support on which a cement plug may sit. The support may maintain the position of the cement plug in the wellbore and minimize cement-plug contamination.

### BACKGROUND

The statements in this section merely provide background information related to the present disclosure and may not constitute prior art.

This disclosure relates to methods for servicing subterranean wells, in particular, fluid compositions and methods for remedial cementing operations.

Remedial cementing is a general term to describe operations that employ cementitious fluids to cure a variety of well problems. Such problems may occur at any time during the life of the well, from well construction to well stimulation, production and abandonment. Remedial cementing is commonly divided into two broad categories—plug cementing and squeeze cementing. Plug cementing consists of placing cement slurry in a wellbore and allowing it to set. Squeeze cementing consists of forcing cement slurry through holes, splits or fissures in the casing/wellbore annular space.

During construction of a subterranean well, remedial operations may be required to maintain wellbore integrity during drilling, to cure drilling problems, or to repair defective primary cement jobs. Wellbore integrity may be compromised when drilling through mechanically weak formations, leading to hole enlargement. Cement slurries may be used to seal and consolidate the borehole walls. Remedial cementing is a common way to repair defective primary cement jobs, to either allow further drilling to proceed or to provide adequate zonal isolation for efficient well production.

During well production, remedial cementing operations may be performed to restore production, change production characteristics (e.g., to alter the gas/oil ratio or control water production), or repair corroded tubulars. During a stimulation treatment, the treatment fluids must enter the target zones and not leak behind the casing. If poor zonal isolation behind the production casing is suspected, a remedial cementing treatment may be necessary.

Well abandonment frequently involves placing cement plugs to ensure long-term zonal isolation between geological formations, replicating the previous natural barriers between zones. However, before a well can be abandoned, annular leaks must be sealed. Squeeze cementing techniques may be applied for this purpose.

Cementitious fluid systems employed during remedial-cementing operations may comprise Portland cement slurries, lime/silica blends, lime/pozzolan blends, calcium-aluminate cement slurries, Sorel cements, zeolites, chemically bonded phosphate ceramics, geopolymers and organic resins based on epoxies or furans.

The most common method for placing a cement plug is the balanced-plug technique (FIG. 1). Tubing or drillpipe 101 is run into the wellbore 102 to the desired depth of the plug base 103. To avoid contamination by other wellbore fluids, appropriate volumes of spacer fluid 104 or chemical wash may be pumped ahead of and behind the cement slurry 105. A displacement fluid or drilling fluid 106 may reside above the spacer fluid. The volumes are such that they correspond to the same heights in the annulus and in the pipe, thus achieving a hydrostatic balance. Once the plug is balanced, the pipe is slowly pulled out of the cement to a depth above the plug, and excess cement slurry is reversed out.

A problem that may arise during placement of a balanced plug is contamination by fluids that reside below the plug. To minimize downward migration of the cement plug, fluids with high gel strengths may be placed as a base 107. Examples of such fluids include thixotropic bentonite suspensions, silicate gels or crosslinked polymer pills. The pills may be weighted to a density higher than that of the cement plug to ensure better stability of the interface. Mechanical devices such as inflatable packers, diaphragms and umbrella-shaped membranes may also be used as bases for a cement plug.

A thorough overview of remedial cementing compositions and practices may be found in the following publication. Daccord G et al.: “Remedial Cementing,” in Nelson E B and Guillot D (eds.): Well Cementing, 2^{nd} Edition, Houston: Schlumberger (2006) 503-547.

### SUMMARY

The present disclosure provides means to prepare and use viscous pills with high-density base fluids.

In an aspect, embodiments relate to compositions comprising water, at least an acrylate monomer or at least a methacrylate monomer or a combination thereof, a free-radical polymerization initiator and a water-soluble bromide salt.

In a further aspect, embodiments relate to methods for placing a cement plug in a subterranean wellbore. A composition is prepared that comprises water, at least an acrylate monomer or at least a methacrylate monomer or a combination thereof, a free-radical polymerization initiator and a water-soluble bromide salt. The composition is placed in the wellbore and the monomer is allowed to polymerize, thereby causing the composition to form a gel. A cement slurry is prepared and placed in the wellbore such that it rests on top or the gel, thereby forming a plug.

In yet a further aspect, embodiments relate to methods for supporting a cement plug in a subterranean wellbore. A composition is prepared that comprises water, at least an acrylate monomer or at least a methacrylate monomer or a combination thereof, a free-radical polymerization initiator and a water-soluble bromide salt. The composition is placed in the wellbore and allowed to polymerize, thereby causing the composition to form a gel. A cement slurry is prepared and placed in the wellbore such that it rests on top or the gel, thereby forming a plug.

The disclosed compositions and methods are advantageous in that the compositions have improved thermal stability.

### BRIEF DESCRIPTION OF THE DRAWINGS

FIG. 1 presents an illustration of a balanced cement plug.

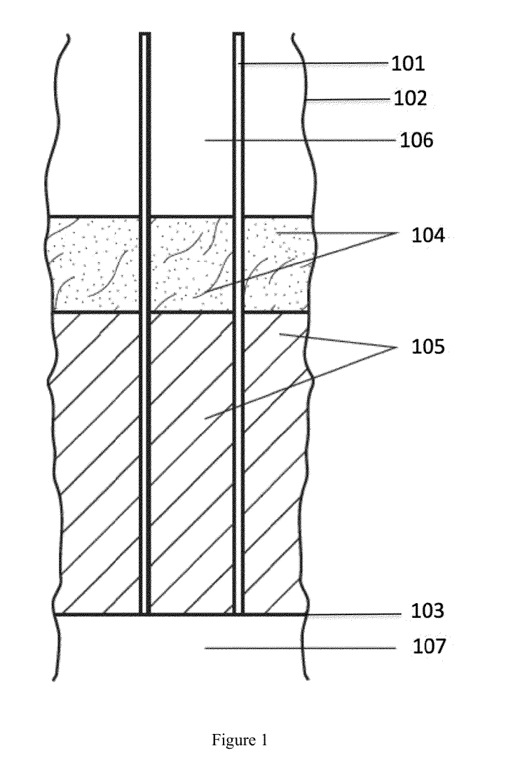

FIGS. 2A, 2B, 2C and 2D present viscosity-versus-time plots for a 2300 kg/m³ (19.2 lbm/gal) CaBr₂/ZnBr₂ brines containing glycidyl methacrylate and a free-radical polymerization initiator. The test temperatures were 93° C., 174° C., 189° C. and 203° C., respectively.

FIGS. 3A and 3B present viscosity-versus-time plots for 2300 kg/m³ (19.2 lbm/gal) CaBr₂/ZnBr₂ brines containing glycidyl methacrylate and a free-radical polymerization initiator. The test temperatures were 214° C. and 229° C., respectively.

FIG. 4 presents viscosity-versus-time plots for 1920 kg/m³ (16.0 lbm/gal) CaBr₂/ZnBr₂ brines containing hydroxyethyl acrylate and a free-radical polymerization initiator. The test temperatures were 180° C., 189° C., 203° C. and 216° C.

FIG. 5 presents a viscosity-versus-time plot for a 1800 kg/m³ (15.0 lbm/gal) CaBr₂/ZnBr₂ brine containing hydroxyethyl methacrylate and a free-radical polymerization initiator. Viscosity of the fluid was measured as the temperature was increased incrementally from ambient to 215° C., while being held at intermediate temperatures of 107, 133, 146, 172, and 198 deg C. for 30 minutes each.

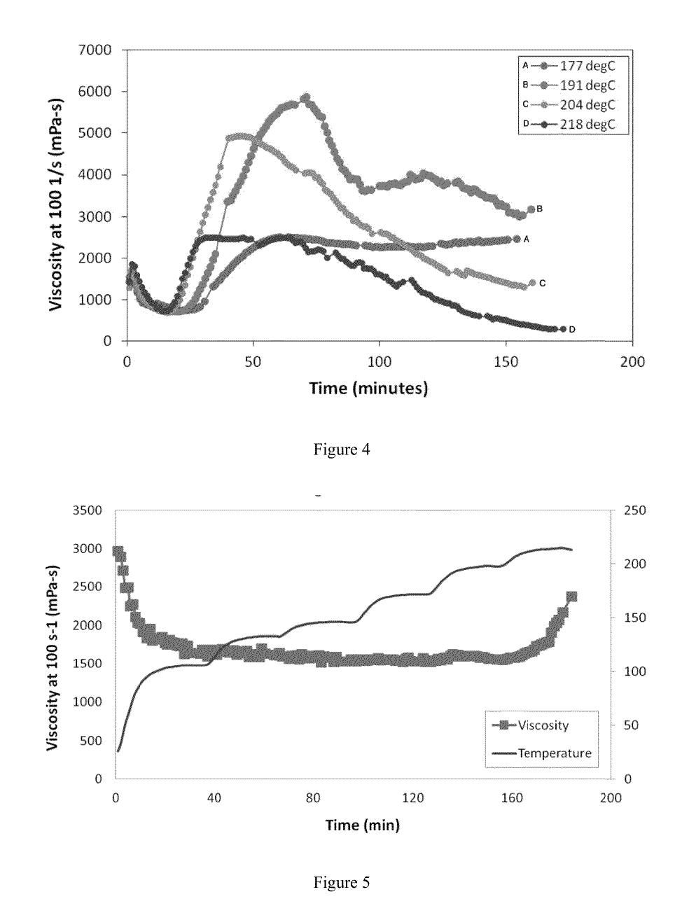

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and the detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood the Applicant appreciates and understands that any and all data points within the range are to be considered to have been specified, and that the Applicant possessed knowledge of the entire range and all points within the range.

The following definitions are provided in order to aid those skilled in the art to understand the detailed description.

The term “treatment,” or “treating,” refers to any subterranean operation that uses a fluid in conjunction with a desired function and/or for a desired purpose. The term “treatment,” or “treating,” does not imply any particular action by the fluid.

As used herein, the term “polymer” or “oligomer” is used interchangeably unless otherwise specified, and both refer to homopolymers, copolymers, interpolymers, terpolymers, and the like. Likewise, a copolymer may refer to a polymer comprising at least two monomers, optionally with other monomers. When a polymer is referred to as comprising a monomer, the monomer is present in the polymer in the polymerized form of the monomer or in the derivative form of the monomer. However, for ease of reference the phrase comprising the (respective) monomer or the like is used as shorthand.

As used herein, the term “pumpable” refers to fluids with a viscosity lower than about 1000 cP at a shear rate of 100 s⁻¹.

As discussed earlier, prior to the placement of a cement plug, a volume of fluid may be pumped into the wellbore to form what is often called a base plug. The function of the base plug is to support the cement plug. The base plug is usually designed such that it not only is more dense than the cement slurry, but also has a higher gel strength or yield stress. Failure to achieve these attributes may lead to an unstable interface between the cement slurry and the base plug, potentially leading to commingling and contamination of both systems.

Bentonite suspensions, silicate gels and crosslinked polymer gels have been used to prepare base plugs. Most of the crosslinked-polymer systems known in the art are based on dissolving high molecular weight polymers such as polysaccharides. Such systems usually demonstrate limited stability at temperatures above about 149° C. (300° F.), and may not be formulated successfully in heavy brines.

The Applicant has determined that some acrylate and methacrylate monomers are soluble in bromide brines, calcium bromide and zinc bromide being the most common. However, persons skilled in the art will recognize that solutions of other soluble bromide salts such as sodium bromide and potassium bromide may be equally appropriate. Upon polymerizing, the resulting acrylate and methacrylate polymers form high-viscosity gels with high yield strengths. Owing to the high density of the bromide brines, gels may be prepared with densities up to at least 2500 kg/m³ (21 lbm/gal). In addition, the gels are thermally stable at temperatures of at least 229° C. (445° F.). An additional benefit is logistical. The required gel density may be achieved by blending the calcium bromide and zinc bromide brines in a desired ratio, obviating the need to add weighting agents such as silica, hematite, calcium carbonate, barium sulfate and the like. However, a combination of brine and solid weighting agents may be used to attain even higher densities.

In an aspect, embodiments relate to compositions. The compositions comprise water, at least one acrylate monomer or at least one methacrylate monomer or a combination thereof, a free radical polymerization initiator and a water-soluble bromide salt.

In a further aspect, embodiments relate to methods for placing a cement plug in a subterranean wellbore. A pumpable composition is prepared that comprises water, at least one acrylate monomer or at least one methacrylate monomer or a combination thereof, a free-radical polymerization initiator and a water-soluble bromide salt. The composition is placed in the wellbore and the monomer is allowed to polymerize, thereby increasing the fluid viscosity and causing the composition to form a gel. A cement slurry is prepared and placed in the wellbore such that it rests on top or the gel, thereby forming a plug.

In yet a further aspect, embodiments relate to methods for supporting a cement plug in a subterranean wellbore. A pumpable composition is prepared that comprises water, an acrylate monomer or a methacrylate monomer or a combination thereof, a free-radical polymerization initiator and a water-soluble bromide salt. The composition is placed in the wellbore and allowed to polymerize, thereby increasing the fluid viscosity and causing the composition to form a gel. A cement slurry is prepared and placed in the wellbore such that it rests on top or the gel, thereby forming a plug.

For all aspects, the monomer may comprise hydroxypropyl methacrylate, glycidyl methacrylate, hydroxyethyl methacrylate, hydroxyethyl acrylate or 4-hydroxybutyl acrylate or a combination thereof. The monomer concentration may be between about 0.001 and 1.0 kg/L, or may be between about 0.01 kg/L and 0.1 kg/L.

For all aspects, the initiator may comprise peroxides, hydroperoxides, or azo compounds or combinations thereof. The initiator may be benzoyl peroxide, hydrogen peroxide, t-butyl peroxide, methylethylketone peroxide, t-butyl hydroperoxide, 2,2′-azobisisobutyronitrile, 1,1′-Azobis(cyclohexanecarbonitrile), 2,2′-azobis(2-aminopropane)dihydrochloride), 2,2′-Azobis{2-methyl-N-[1,1-bis(hydroxymethyl)-2-hydroxyethyl]propionamide}, 2,2′-Azobis[2-methyl-N-(2-hydroxyethyl)propionamide], 2,2′-Azobis(1-imino-1-pyrrolidino-2-ethylpropane)dihydrochloride, 2,2′-Azobis[2-(2-imidazolin-2-yl)propane], 2,2′-Azobis {2-[1-(2-hydroxyethyl)-2-imidazolin-2-yl]propane}dihydrochloride, 2,2′-Azobis[N-(2-carboxyethyl)-2-methylpropionamidine]hydrate, 2,2′-Azobis[2-(2-imidazolin-2-yl)propane]disulfate dihydrate, or 2,2′-Azobis[2-(2-imidazolin-2-yl)propane]dihydrochloride or combinations thereof. The initiator concentration may be between about 0.00001 kg/L and about 0.01 kg/L, or may be between 0.0001 kg/L and 0.01 kg/L.

For all aspects, the bromide salt may comprise calcium bromide, zinc bromide, sodium bromide or potassium bromide or combinations thereof. The density of the composition may vary between about 720 kg/m³ (6.0 lbm/gal) to at least 2500 kg/m³ (20.8 lbm/gal), or may vary between about 1000 kg/m³ and about 2500 kg/m³. Formulating bromide brines with densities approaching 1000 kg/m³ may require further density-reducing means. Such means may comprise foaming the composition, adding low-density particulate materials such as ceramic or glass microspheres, unitaite, unitahite or a combination thereof. Formulating bromide brines with densities exceeding about 2500 kg/m³ may require the addition of solid weighting agents. Such weighting agents may comprise silica, hematite, ilmenite or manganese tetraoxide or combinations thereof.

### EXAMPLES

The following examples serve to better illustrate the present disclosure.

An acrylate and two methacrylate monomers (all obtained from Sigma Aldrich) were tested in the following examples—hydroxyethyl acrylate (HEA), glycidyl methacrylate (GM) and hydroxyethyl methacrylate (HEM). The polymerization initiator was 2,2′-Azobis(2-methylpropionamidine)dihydrochloride (available from Sigma Aldrich).

Bromide brines of various densities were prepared by combining a 1700-kg/m³ (14.2-lbm/gal) CaBr₂ brine with a 2300-kg/m³ (19.2-lbm/gal) CaBr₂/ZnBr₂ blended brine. The brines were supplied by MI-Swaco, Houston, Tex. Table 1 presents the blends employed to prepare bromide brines that were used in the examples.

TABLE 1
Brine blends employed to obtain fluids of various densities.

| Brine | Vol. | Vol. | Mass | Mass | Mass |
|---|---|---|---|---|---|
| Density | Fraction | Fraction | Fraction | Fraction | Fraction |
| (kg/m³) | CaBr₂ | CaBr₂/ZnBr₂ | CaBr₂ | ZnBr₂ | Water |
| 1700 | 1.00 | 0.00 | 0.52 | 0.00 | 0.48 |
| 1800 | 0.84 | 0.16 | 0.45 | 0.11 | 0.44 |
| 1920 | 0.64 | 0.36 | 0.38 | 0.24 | 0.39 |
| 2040 | 0.44 | 0.56 | 0.31 | 0.34 | 0.34 |
| 2160 | 0.24 | 0.76 | 0.26 | 0.44 | 0.30 |
| 2280 | 0.04 | 0.96 | 0.20 | 0.53 | 0.27 |
| 2300 | 0.00 | 1.00 | 0.20 | 0.55 | 0.26 |

Various solutions of polymerized acrylate and methacrylate were prepared, and their rheological properties were measured versus time and temperature. The rheological data were generated with a Grace M5600 rheometer.

### Example 1

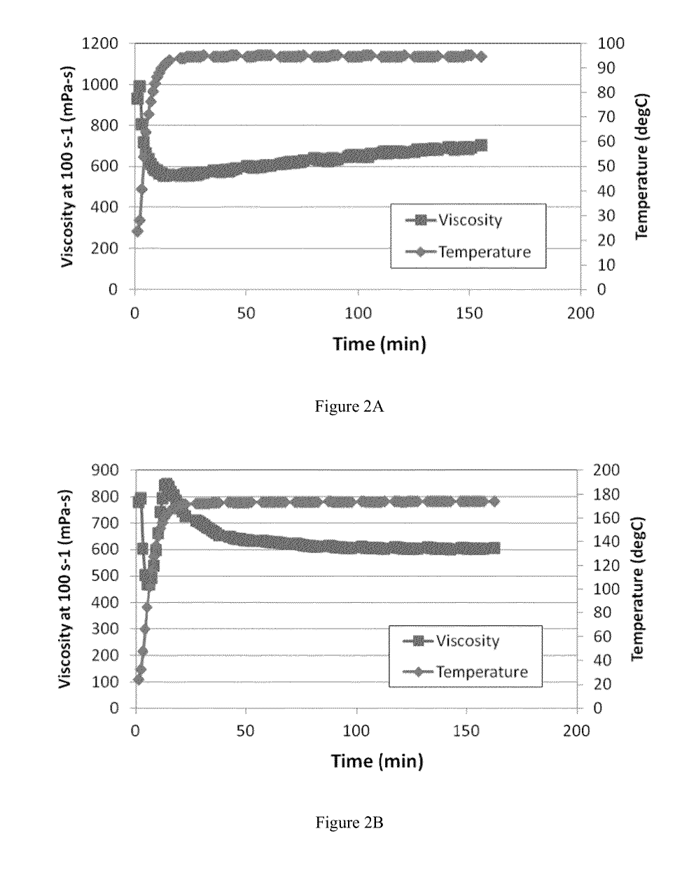

Fluids were prepared with the following composition: 200 mL of 2300 kg/m³ (19.2 lbm/gal) CaBr₂/ZnBr₂ brine, 0.2 g of initiator and 10 mL of GM. The fluid was aged in a 66° C. oven for two days. After aging, the fluids were placed in the rheometer and the viscosity versus time was measured at four temperatures: 93° C., 174° C., 189° C. and 203° C. The results are presented in FIGS. 2A, 2B, 2C and 2D, respectively.

The fluids were stable at all three temperatures during a 150-min test period. Interestingly, the fluid viscosity at 203° C. was higher than those at lower temperatures, and the viscosity increased with time. The sample recovered from the rheometer after the test was a rubbery solid. These results indicate that, apart from their high density, GM gels display high temperature stability as well as mechanical strength.

### Example 2

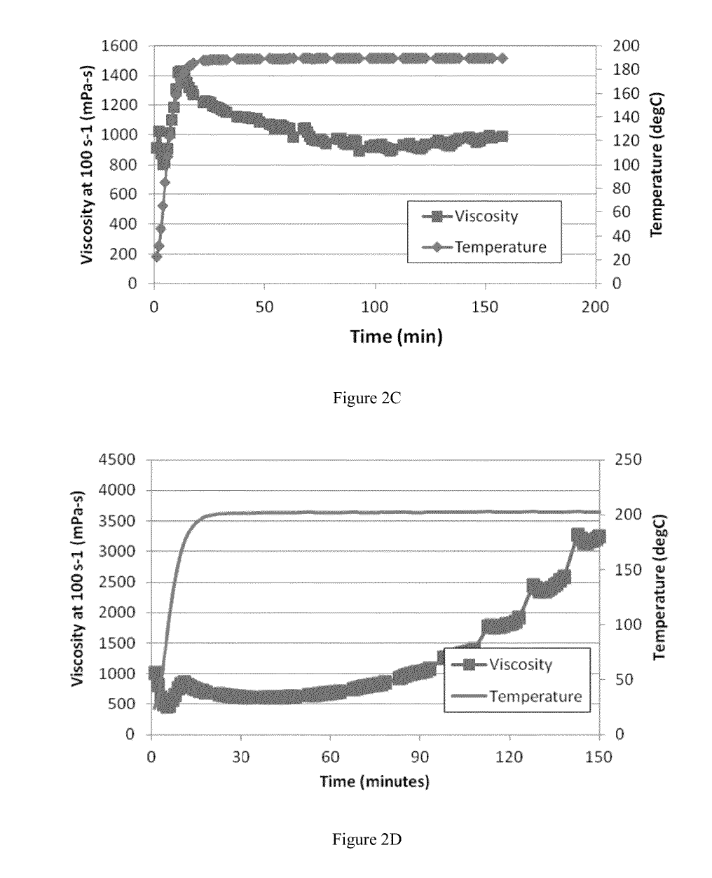

Fluids were prepared with the following composition: 200 mL of 2300 kg/m³ (19.2 lbm/gal) CaBr₂/ZnBr₂ brine, 0.1 g of initiator and 5 mL of GM. The fluid was aged in a 66° C. oven for 16 hours. After aging, the fluids were placed in the rheometer and the viscosity versus time was measured at two temperatures: 214° C. and 229° C. The test duration was 175 min. The results are presented in FIGS. 3A and 3B, respectively.

At these temperatures, the fluids underwent an initial viscosity increase, followed by a viscosity decrease. After the tests, the fluids recovered from the rheometer were dark in color, indicating polymer degradation. Nevertheless, the fluids maintained a high viscosity (thousands of cP) for nearly two hours.

### Example 3

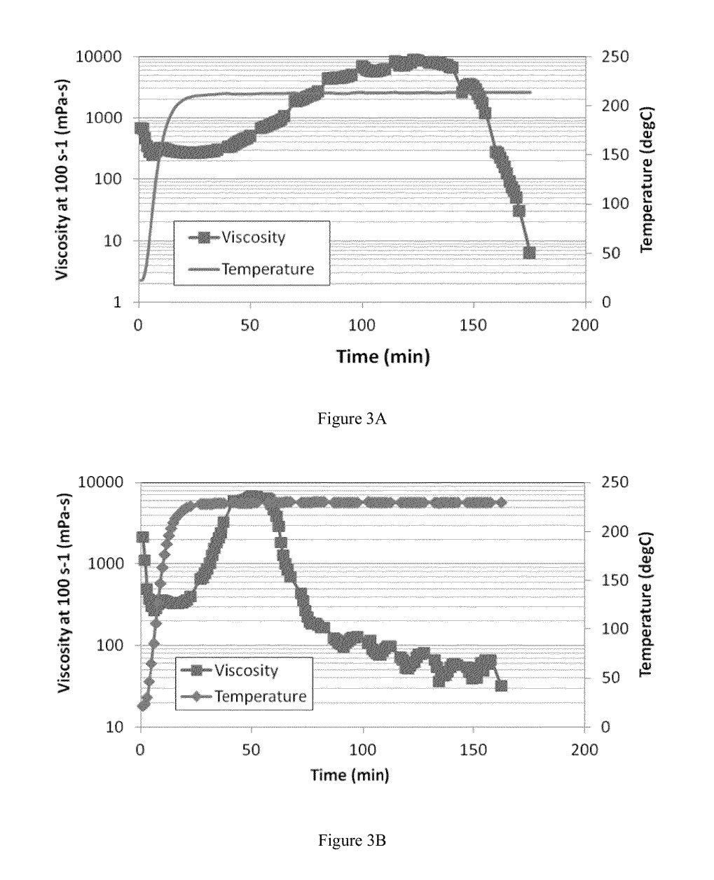

Fluids were prepared with the following composition: 200 mL of 1920 kg/m³ (16.0 lbm/gal) CaBr₂/ZnBr₂ brine, 0.2 g of initiator and 14.0 g HEA. The fluids were aged in a 66° C. oven for 24 hours. After aging, the fluids were placed in the rheometer and the viscosity versus time was measured at four temperatures: 180° C., 189° C., 203° C. and 216° C. The test duration was 175 min. The results are presented in FIG. 4. The fluids generally maintained fluids viscosities exceeding 1000 cP during most of the test period.

### Example 4

A fluid was prepared with the following composition: 100 mL of 1800 kg/m³ (15.0 lbm/gal) CaBr₂/ZnBr₂ brine, 0.01 g of initiator and 5.0 g HEM. The fluids were aged in a 66° C. oven for 24 hours. After aging, the fluid was placed in the rheometer and the viscosity versus time was measured. The temperature was ramped up from ambient to 215° C. during a 175-min test period. The results are presented in FIG. 4. The fluids generally maintained fluids viscosities exceeding 1500 cP during the test period.

Although various embodiments have been described with respect to enabling disclosures, it is to be understood that the preceding information is not limited to the disclosed embodiments. Variations and modifications that would occur to one of skill in the art upon reading the specification are also within the scope of the disclosure, which is defined in the appended claims.

1. A composition, comprising:
(i) water;
(ii) at least one acrylate monomer or at least one methacrylate monomer or a combination thereof;
(iii) a free radical polymerization initiator; and
(iii) a water-soluble bromide salt.

2. The composition of claim 1, wherein the monomer comprises hydroxypropyl methacrylate, glycidyl methacrylate, hydroxyethyl methacrylate, hydroxyethyl acrylate or 4-hydroxybutyl acrylate or a combination thereof.

3. The composition of claim 1, wherein the monomer concentration in the composition is between 0.001 kg/L and 1.0 kg/L.

4. The composition of claim 1, wherein the initiator comprises peroxides, hydroperoxides or azo compounds or combinations thereof.

5. The composition of claim 1, wherein the initiator concentration in the composition is between 0.00001 kg/L and 0.01 kg/L.

6. The composition of claim 1, wherein the bromide salt comprises calcium bromide, zinc bromide, sodium bromide or potassium bromide, or a combination thereof.

7. The composition of claim 1, wherein the density of the composition is between 720 kg/m³ and 2500 kg/m³.

8. A method for setting a cement plug in a subterranean wellbore, comprising:
i. preparing a composition comprising:
a. water;
b. at least one acrylate monomer or at least one methacrylate monomer or a combination thereof;
c. a free radical polymerization initiator; and
d. a water-soluble bromide salt;
ii. placing the composition into the wellbore;
iii. allowing the monomer in the composition to polymerize, thereby causing the composition to form a gel;
iv. preparing a cement slurry; and
v. placing the slurry in the wellbore.

9. The method of claim 8, wherein the monomer comprises hydroxypropyl methacrylate, glycidyl methacrylate, hydroxyethyl methacrylate, hydroxyethyl acrylate or 4-hydroxybutyl acrylate or a combination thereof.

10. The method of claim 8, wherein the monomer concentration in the composition is between 0.001 kg/L and 1.0 kg/L.

11. The method of claim 8, wherein the initiator comprises peroxides, hydroperoxides or azo compounds or combinations thereof.

12. The method of claim 8, wherein the initiator concentration in the composition is between 0.00001 kg/L and 0.01 kg/L.

13. The method of claim 8, wherein the bromide salt comprises calcium bromide, zinc bromide, sodium bromide or potassium bromide, or a combination thereof.

14. The method of claim 8, wherein the density of the composition is between 720 kg/m³ and 2500 kg/m³.

15. A method for supporting a cement plug in a subterranean wellbore, comprising:
i. preparing a composition comprising:
a. water;
b. at least one acrylate monomer or at least one methacrylate monomer or a combination thereof;
c. a free radical polymerization initiator; and
d. a water-soluble bromide salt;
ii. placing the composition into the wellbore;
iii. allowing the monomer in the composition to polymerize, thereby causing the composition to form a gel;
iv. preparing a cement slurry; and
v. placing the slurry in the wellbore,
wherein, the density of the composition is between 720 kg/m³ and 2500 kg/m³.

16. The method of claim 15, wherein the monomer comprises hydroxypropyl methacrylate, glycidyl methacrylate, hydroxyethyl methacrylate, hydroxyethyl acrylate or 4-hydroxybutyl acrylate or a combination thereof.

17. The method of claim 15, wherein the monomer concentration in the composition is between 0.001 kg/L and 1.0 kg/L.

18. The method of claim 15, wherein the initiator comprises peroxides, hydroperoxides or azo compounds or combinations thereof.

19. The method of claim 15, wherein the initiator concentration in the composition is between 0.00001 kg/L and 0.01 kg/L.

20. The method of claim 15, wherein the bromide salt comprises calcium bromide, zinc bromide, sodium bromide or potassium bromide, or a combination thereof.
